(19) United States
(12) Patent Application Publication
(10) Pub. No.: US 2008/0147502 A1
(43) Pub. Date: Jun. 19, 2008

(54) EXERCISE INCENTING METHODS AND DEVICES

(76) Inventor: Steve G. Baker, Redmond, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/872,937

(22) Filed: Oct. 16, 2007

Related U.S. Application Data
(60) Provisional application No. 60/856,999, filed on Nov. 6, 2006.

(51) Int. Cl. G06Q 99/00; G06F 15/16

(52) U.S. Cl. 705/14; 709/203

(57) ABSTRACT

Methods, systems, and apparatuses for receiving or sending verification that an incentee user has performed a physical exercise prescribed by an incenting arrangement, with an incentee user agreeing to perform the physical exercise in order to obtain a reward for a reward recipient, and initiating—upon receipt of said verification—a providing or provisioning of the reward to the reward recipient.

### RELATED APPLICATIONS

This application claims the benefit of U.S. Provisional Application No. 60/856,999 filed Nov. 6, 2006.

### FIELD OF THE DISCLOSURE

Embodiments of the disclosure relate to the field of computer science, in particular to methods, systems, and apparatuses for verifying that an incentee user has performed a prescribed exercise and providing a reward to the incentee user upon verification.

### BACKGROUND OF THE DISCLOSURE

Obesity, high blood pressure, and diabetes are issues facing many. In particular, obesity affects more children today than ever before and parents, educators, and other concerned adults struggle to encourage children—as well as other adults—to exercise.

Fitness clubs provide gym members with incentive points for visiting a gym. These points may be used to purchase goods or services provided by the fitness club. But exercising outside the gym is not rewarded with incentive points, and a user need only visit the gym. He or she does not need to exercise at a prescribed level, perform any specific exercises, or even exercise at all. There is no way to verify that a user actually exercises.

Some online service providers allow parents or others to track children's chores online and to provide online monetary incentives to do their chores. Once children perform their chores, money subsequently transfers to an online account. These services providers do not provide a child or other user with an incentive to exercise, do not verify that children exercise, and do not provide a reward for exercising.

### BRIEF DESCRIPTION OF THE DRAWINGS

Embodiments of the disclosure will be readily understood by the following detailed description in conjunction with the accompanying drawings. Embodiments of the disclosure are illustrated by way of example and not by way of limitation in the figures of the accompanying drawings.

FIG. 1 depicts an overview of an incenting process including incenting, monitoring, exercise, verification and payment in accordance with embodiments;

FIG. 2 shows an incenting arrangement setup process in accordance with embodiments;

FIG. 3 depicts an exercise validation and verification process in accordance with embodiments;

FIG. 4 shows a reward provisioning process in accordance with various embodiments;

FIG. 5 shows a reward provisioning process including an escrow account hosted by an incenting computer system in accordance with embodiments;

FIG. 6 shows a reward provisioning process wherein an incentor user holds two accounts in accordance with various embodiments;

FIG. 7 shows a reward provisioning process wherein an incentor user preauthorizes payments from one of two accounts in accordance with various embodiments;

FIG. 8 shows a block diagram of an incenting system in accordance with embodiments; and

FIG. 9 shows a server system suitable for practicing various embodiments of the present invention.

### DETAILED DESCRIPTION

In the following detailed description, reference is made to the accompanying drawings which form a part hereof, and in which is shown by way of illustration embodiments of the disclosure. It is to be understood that other embodiments may be utilized and structural or logical changes may be made without departing from the scope of the disclosure. Therefore, the following detailed description is not to be taken in a limiting sense, and the scope of embodiments in accordance with the disclosure is defined by the appended claims and their equivalents.

Various operations may be described as multiple discrete operations in turn, in a manner that may be helpful in understanding various embodiments; however, the order of description should not be construed to imply that these operations are order dependent.

The terms “coupled” along with its derivatives, may be used. It should be understood that these terms are not intended as synonyms for each other. Rather, in particular embodiments, “coupled” may mean that two or more elements are in direct physical or electrical contact. However, “coupled” may also mean that two or more elements are not in direct contact with each other, but yet still cooperate or interact with each other.

The description may use the phrase, “various embodiments,” “in an embodiment,” or “according to one embodiment,” which may refer to one or more of the same or different embodiments. Furthermore, the terms “comprising,” “including,” “having,” and the like, as used with respect to embodiments as described in the present disclosure, are synonymous.

Embodiments include a system for verifying that an incentee user completes physical exercise, or other prescribed activity and, upon such verification, providing a reward recipient, such as for example an incentee user, with a reward. The physical exercise and the reward may be prescribed by an incenting arrangement wherein an incentee user agrees to perform the physical exercise in order to obtain a reward for a reward recipient. In embodiments, the incentee user and a reward recipient may be the same. In embodiments, an activity monitor for recording and verifying that the incentee performed the physical exercise may be used. The activity monitor may monitor a wide variety of physical exercise and/or play and may be compatible with a wide variety of equipment, including commercially available computer systems, exercise equipment, game console equipment, among others. For example, a young child may wear a monitoring device while playing tag, exercising on a jungle gym, or playing soccer. The monitoring device may record physiological data or other data. The monitoring device may, in embodiments, be configured to upload the recorded physiological data or other data to a computer system for transmission to an incenting server system.

Embodiments may be simple enough that a parent can easily set up an incenting arrangement and a child can operate it. Embodiments may provide a sufficiently rapid reward to effectively incent a person, such as a child, who may have a short attention span and a desire for “instant gratification”.

Embodiments may enable an incentor user to offer a reward based upon reaching a prescribed medium-to-long-term-objective.

Embodiments may include an agent, such as a server or server system, acting as an intermediary between an incentor user and an incentee user. More particularly, the incentor user may attempt to provide an incentive to the incentee user to perform physical exercise by establishing an arrangement including a prescribed exercise, or exercise level, for the incentee user to perform and a proposed reward for sending verification that the prescribed exercise has been performed. A person may act as an incentor user to encourage their child, parent, or other loved one to exercise. In embodiments, the incentive reward may be used to buy clothes or other merchandise on selected web sites or in a physical retail store. In embodiments, the incentive reward may be credit to download music files or ringtones or to take a trip.

In embodiments a party controlling the incenting computer system may charge a commission to one or more of the users or to other parties such as, for example, merchants. In embodiments, the incenting computer system may include a web server(s) and may display paid advertising to viewers of a website(s) hosted on the web server(s). In embodiments, users may view a website including paid advertising on a mobile phone, personal data assistant (PDA), or other handheld wireless device.

In embodiments, an incentor user may purchase incentive credit and may deposit it into an account, such as an escrow or other account. In embodiments, the incentive credit may be money or credit for a particular merchandise or service. In embodiments, goods or services may be offered at a discount through a preferred merchant. A user account may be accessible via an information network or other network and may, in embodiments, take the form of a password secured web-site. In embodiments, a user account may be accessible via email and/or telephone. In embodiments, the incentor user may be able to purchase incentive credit using a credit card, debit card, electronic funds transfer, check, PayPal™, or other. The incentee user may establish an account, designate an incentive reward, and request a particular person(s) to be an incentor user. In such embodiments, the requested incentor user(s) may purchase incentive credit. A person may establish an incenting arrangement and designate themselves as both incentee user and incentor user by depositing incentive credit and prescribing an exercise or level of exercise as well as a proposed reward. In embodiments, an incentive reward may be non-monetary such as written praise for performing the prescribed exercise or exercise level. Such non-monetary rewards may include an electronic message telling the incentee user they have earned the right to do a predetermined fun activity.

The incentee user may perform part of or all of the prescribed physical exercise to earn some or all of the proposed reward. The incentee user may use an activity monitoring device to record evidence of performing the activity. The incentee user may submit exercise data to the incenting computer system. The incentor user or the incenting computer system may require the incentee user submit verification, such as an exercise record, to substantiate the claim. The account may record the incentee user's cumulative exercise and exercise levels. In embodiments, the incentor user, a person associated with the incenting computer system, and/or the incentee user may view the incentee user's exercise records and track progress over time.

Embodiments may be sufficiently simple so that a busy parent or child may operate them. The monitoring device may be wearable and may be configured to monitor multiple exercise sessions throughout a day, week, month, or other specified time period. As an example only, an incentee user—such as a young child—may wear a monitoring device such as for example heart rate monitor, play tag for a while, play on a jungle gym, rest for a few minutes, play more tag, and then ride a bike. The monitoring device may record all of these activities without requiring the incentee user to remember to take the monitoring device from place-to-place and without requiring the incentee user to remember to turn the monitor on or off each time they change activities. Data transfer may be partially automated. The activity monitor may automatically wirelessly transmit exercise data to an incentee device, such as for example a computer, when the incentee user brings the activity monitor close to the computer. The incentee device may automatically transmit data, such as an exercise record, to the incenting computer system.

The incenting computer system may process information and make transactions on behalf of the incentor user or incentee user. For example the incentor user may pre-authorize the incenting computer system to transfer money to an incentee user's account from an incentor user's account.

One object of the present invention may be to provide sufficiently fast reward to effectively incent a person such as a child with a short attention span and with a desire for “instant gratification”, thus overcoming the limitations of the prior art. For example the system may be designed to enable the incentee to receive payment within minutes of performing a prescribed exercise even if the incentor user is not present or involved in the transaction. In embodiments, money may be electronically transferred from an incentor's account into an incentee's debit card account or other account.

Another object of the present invention may be to enable the incentor user to propose a reward based upon the incentee user reaching a medium-to-long-term physical exercise objective thus encouraging the incentee user to work towards a goal.

As an example only, the incentor user may propose a reward based upon the incentee user exercising a certain number of times over a period or a certain amount of time over a period.

In embodiments, an incentee device or a monitoring device may transmit exercise data and/or an exercise record to an incenting computer system via the internet using for example standard or nonstandard protocols such as HTTP, FTP, POP3, SMTP, telnet, or other. In embodiments, exercise data and/or an exercise record may be transmitted via a mobile phone network using, for example, text messaging such as SMS or MMS, email, or other communications technologies. In embodiments, exercise records and/or exercise data may be sent automatically at predetermined intervals. For example, an incentee device or incenting computer system may schedule an automatic reminder to be sent to the incentee device and/or user after a certain period inactivity, such as, for example, three days or other time period. The incentee device and/or user may schedule an automatic upload of exercise data and/or an exercise record after an exercise session of performing a prescribed physical exercise.

The prescribed exercise may be a game, such as a video or computer game that requires exercise. The incentee user may use and/or wear a monitoring device to record exercise data, such as physiological data, or other data related to performing physical exercise such as gross arm movement, heart rate, or footsteps, among others. The monitoring device may, in embodiments, record data related to the incentee user interacting with a game platform such as a Nintendo™ Wii or a personal computer and/or an online multi-player game. Such a monitoring device may be used with any standard game including any video or computer game. In embodiments, the monitoring device may be implemented as a computer module, such as a shell program that the standard game runs within. Alternatively, the monitoring device may be a computer module that interposes itself between a computer game player and the standard game to monitor game activity. In embodiments, the monitoring device may be a hardware device. In embodiments, a standard game controller output may plug into an input port of the monitoring device such as, for example, a USB port. In embodiments, the monitoring device may have outputs which may plug into a game system such as, for example, a USB port on a personal computer. The monitoring device may record exercise data or other data and pass user control movements through to the game system.

In embodiments, the monitoring device may record and transmit one or more of time, duration, amount, intensity, or other exercise data. In embodiments, the monitoring device may include a GPS receiver. In embodiments, the monitoring device may be a foot strike indicator in a shoe and may include a wireless transmitter to transmit to another device, such as an incentee device, using Bluetooth™ or other Personal Area Networking (PAN) communications protocol or other type of wireless or wired communications protocol. Such an incentee device may, in embodiments, be a mobile smart phone carried by the incentee user. In embodiments, the monitoring device may be a pedometer worn on the body. In embodiments, the monitoring device may be an ergometer configured for use on exercise equipment such as, for example, a bicycle, rowing machine, or other exercise equipment.

In embodiments, the monitoring device may be a heart rate monitor with a sensor in a chest strap, shirt, glove, fingertip sensor, headband, sock, or other.

In embodiments where the prescribed activity is a computer game or where the monitoring device interfaces with a computer system and/or gaming module, a game controller may be designed to require a moderate to substantial physical exertion to operate. In embodiments, a video or computer game may use a motion sensing controller that requires exertion to operate.

Alternatively, a device configured to increase a level required effort, intensity, or exertion may be attached to a game controller or to the game player. In embodiments, such an effort-increasing-device may be put into the field of play. In embodiments, the effort-increasing-device may increase the force required to play a game. This may increase exercise intensity while using standard controller hardware and software. This may in turn allow the incentee user to play standard games without requiring the games to be modified to be compatible with the incentive system. In embodiments, the effort-increasing-device may be attached directly or indirectly via a cable or linkage. In embodiments, the effort-increasing-device may be a weight, an elastic cord, an elastic beam, a friction brake band, an adjustable disc brake, a friction pad, a hydraulic resistance piston, a hydraulic turbine, a magnetic particle brake, an electromagnetic brake, or other.

In embodiments, the player may be required to exercise while partially submerged in a resisting medium such as a pile of balls or a pool of water or a fluidized bed of sand. A layer of balls may cover a foot-controlled controller to increase the player's effort required to move their feet. In embodiments, a weight may be attached to the incentee user's body and a camera and image analyzer configured to sense the incentee user's motion may be used.

In embodiments, the methods, systems, and apparatuses described herein may be used for fundraising or charity event accounting. The benefactor incentor(s) may propose a reward paid to a reward recipient, such as for example a designated beneficiary, instead of to one or more incentee users. Such fundraising or charity events may, in embodiments, occur at one time and place—such as for example a walkathon—or may, in alternative embodiments, occur over a span of time and a region of space.

In embodiments, multiple incentee users may combine their physical exercise data to achieve a common reward.

The phrase “computer system” as used within the specification and claims may refer to one or more computing devices. In embodiments, a computer system may be configured to perform one or more of the functions described throughout the specification. In embodiments computing devices may be arranged as a distributed computer system, a peer-to-peer computer system, a cluster of computers, a server farm, and/or a single computing device. In embodiments, some computing devices of a computer system may perform some functions while other computers in the same computer system may perform other functions. The phrase “incenting computer system” may include one or more computer systems to perform various functions described throughout the specification.

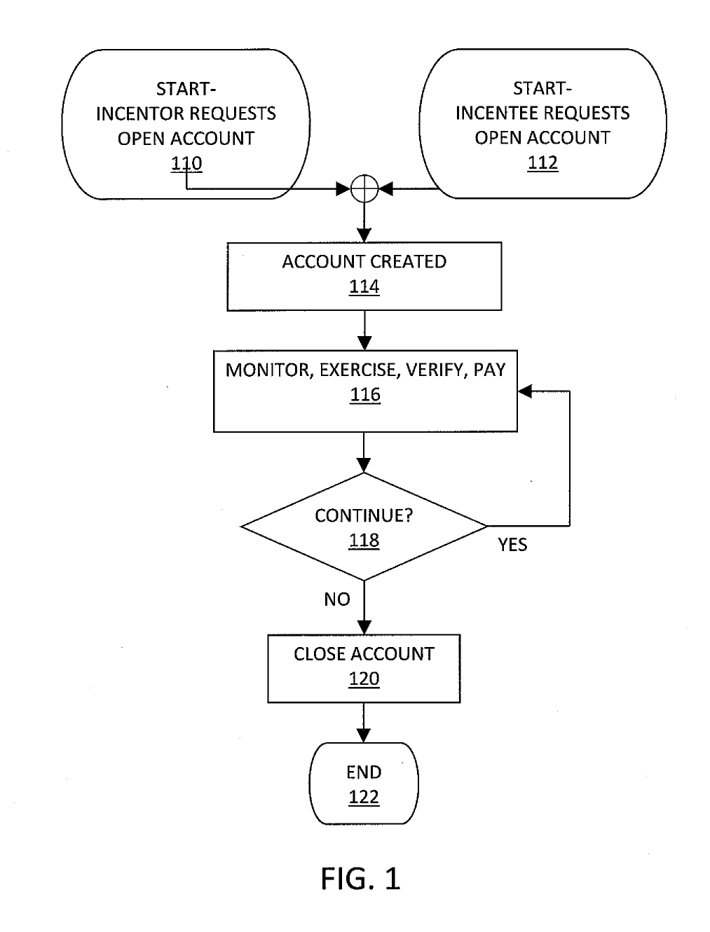

FIG. 1 depicts an overview of an incenting process including incenting, monitoring, exercise, verification and payment in accordance with embodiments. The process may begin when an incentor user opens an account 110 or when an incentee user opens an account 112. In embodiments, the incentee and/or incentor user may submit a request using a computing device such as a personal computer, laptop, handheld device, or other device. In embodiments, the request may be made by browsing to a website included within an incenting computer system and entering account data. In embodiments, the incentor user or incentee user may set up and/or agree to an arrangement wherein the incentor user agrees to provide a reward to the incentee user if the incentee user performs an exercise or other activity. In embodiments, the arrangement may specify that the reward may be provided by the incenting computer system. In alternative embodiments, providing the reward may be initiated by the incenting computer system. In such embodiments, the reward may be provided by a third party such as a vendor, bank, service provider, or by the incentor user. Embodiments are not meant to be limited to any subset of reward providers. In embodiments, some or all of the reward may be provided to a reward recipient. The reward recipient may be, in embodiments, a third party such as a charitable organization or other entity or person. In embodiments the reward recipient may be the incentee user. In embodiments, the reward recipient may be the incentor user. The incenting computer system may open an account using the entered data 114 and establish the agreement. In embodiments, the incentee user may monitor exercise activity, the incenting computer system may verify the exercise, and provide the incentee user with a reward 116. In embodiments, the incentee user may be paid directly by the incentor user. In embodiments, the incenting computer system may provide a prescribed reward to the incentee. In embodiments, the reward may be provided by automatic transfer of monetary funds, credits, or other electronic payments between an account of the incentor user and the incentee user. In embodiments, one or both of those accounts may be held by an organization associated with the incenting computer system, or with a different organization such as a bank. At 118 a user may decide to end the incenting agreement or, in embodiments, the incenting agreement may end after a certain period of time or when the incentee user reaches a fitness goal, performs a certain number of exercises, or if some other prescribed event occurs. At this point, the account may close 120, and the incenting arrangement may end 122.

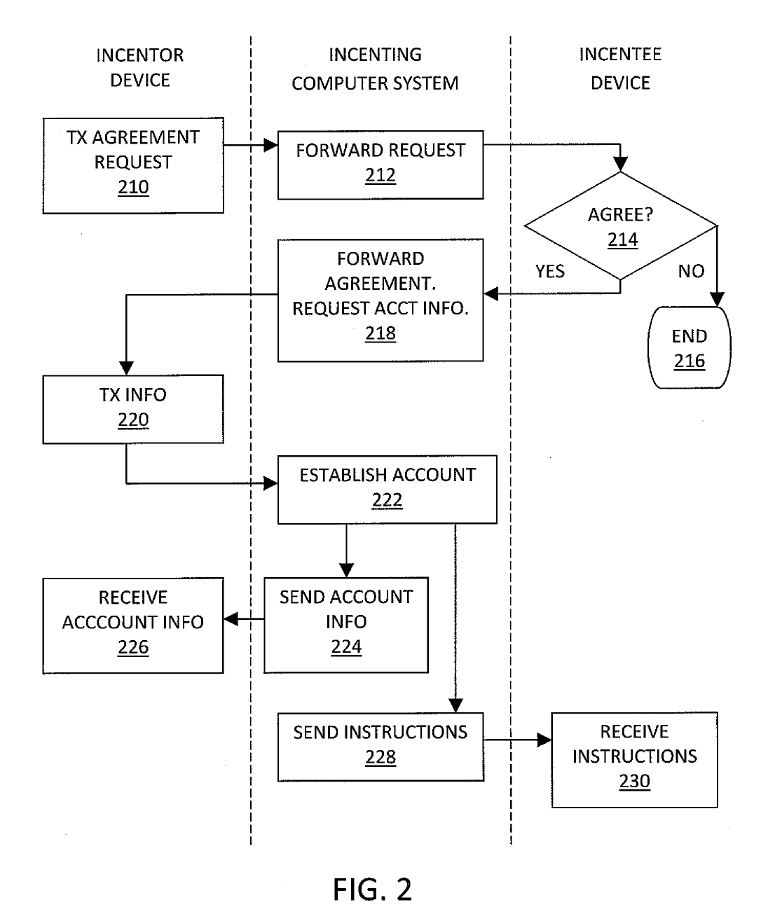

FIG. 2 shows the interaction between an incentor device, an incenting computer system, and an incentee device according to embodiments. In embodiments, the incentor device and the incentee device may be the same. In embodiments, the incentee device may change over the course of time, such that an incentee user may initially accept an arrangement using one device, and receive information using another. In embodiments, an incentor user may operate the incentor device and an incentee user may operate the incentee device. The incentor device may send an electronic request to begin a proposed incenting arrangement to the incenting computer system at 210. The proposed incentive arrangement may include an identity of the incentee user, an identity of the incentee device, a proposed reward and/or a prescribed physical exercise or exercise level to be performed by the incentee user in exchange for the proposed reward, as well as other details.

In embodiments, the prescribed exercise or exercise level may be expressed as a frequency or intensity of exercise. In embodiments, the prescribed exercise or level of exercise may be expressed as a physiological measure of the incentee user. Such physiological measures may include heart rate information such as, for example, an average heart rate, a maximum heart rate, and/or an amount of time spent above a specific heart rate and/or time spent within a target heart rate range. Such physiological measures may include energy information, such as, for example, a number of Calories burned, a number of Calories burned as a function of time, and/or an amount of time spent at or above a certain metabolic rate. In embodiments, physiological measures may include body weight information, body fat percentage information, respiration rate, and/or body mass index (BMI) information, and others. Embodiments are not limited by any specific physiological information. Such physiological information may be measured in embodiments by a monitoring device as described below, and automatically uploaded to the incenting computer system; in embodiments, physiological information may be self-measured by an incentee user, incentor user, or other person. In embodiments, physiological measures may be self-reported by an incentee user, incentor user, or other person.

In embodiments, the prescribed exercise or exercise level may be expressed as an amount of time spent exercising, specific exercise activities to be completed by the incentee user, a certain number of footsteps to be taken by the incentee user, a number of occurrences of a specific physical exercise activity to be performed by the incentee user over a period of time, a distance to be traveled by the incentee user, speed measurements such as an average speed to be achieved by the incentee user, and/or others. In embodiments, the prescribed exercise or exercise level may be expressed as a level of force to be exerted by the incentee user, a range of motion to be executed by the incentee user, and/or others. Embodiments are not limited to any specific exercise or exercise levels. In embodiments, the prescribed exercise or exercise level may include multiple measurements including multiple physiological measures or other measures. In embodiments, the prescribed exercise or exercise level may be measured using a composite of various measurements such as the measurements described above.

In embodiments, the prescribed exercise may be a game, such as a computer game, which requires exertion on the part of the incentee user. In embodiments, the prescribed exercise or exercise level may be measured by a score generated by such a game.

In embodiments, the proposed reward may be monetary. Such monetary rewards may be calculated at an hourly payment rate such as, for example an hourly payment rate for an amount of time spent exercising, an amount of time spent exercising within a desired heart rate range, an amount of time spent exercising at or above a target heart rate, an amount of time spent exercising at a certain metabolic rate, or other. The proposed reward may be, in embodiments, an item, trip, credit to an online store, or other payment. In embodiments, a proposed reward may be an improved status in a computer game, video game, and/or online game.

The incenting computer system may forward the request to the incentee device at 212. The forwarded request may include, in embodiments, the prescribed exercise or level of exercise, the proposed reward for performing the exercise or exercise level, an identity of the incentor user, incentee user, and/or other information. If the incentee user chooses to accept the arrangement, the incentee device may forward an agreement to enter into the proposed arrangement at 214. If the incentee user declines the proposed arrangement, the process may end at 216. In embodiments, the incentee device may notify the incenting computer system and/or the incentee device of the declined proposal. Upon receipt of the agreement, the incenting computer system may send notice to the incentor device along with a request for information in order to open an incentor account at 218. The incentor device may supply information to open the incentor account at 220; the incenting computer system may then open the incentor account at 222. In embodiments, the incenting computer system may manage the incentor account. In embodiments, the incentor user may have a separate account, for example a bank account or other account, and may establish the separate account as the incentor account. The incenting computer system may send notification of the established incentor account to the incentor device and/or instructions for managing the agreed arrangement, monitoring exercise, accessing the account, operating the incenting computer system—including a user interface of the incenting computer system, and/or other instructions/information—at 224. The incentor device may receive account details and instructions at 226. Also the incenting computer system may send the incentee device a notice including instructions for using the incenting computer system including how to use a user interface, how to monitor exercise, how to report exercise, and/or other information at 228. The incentee user may receive those instructions at 230.

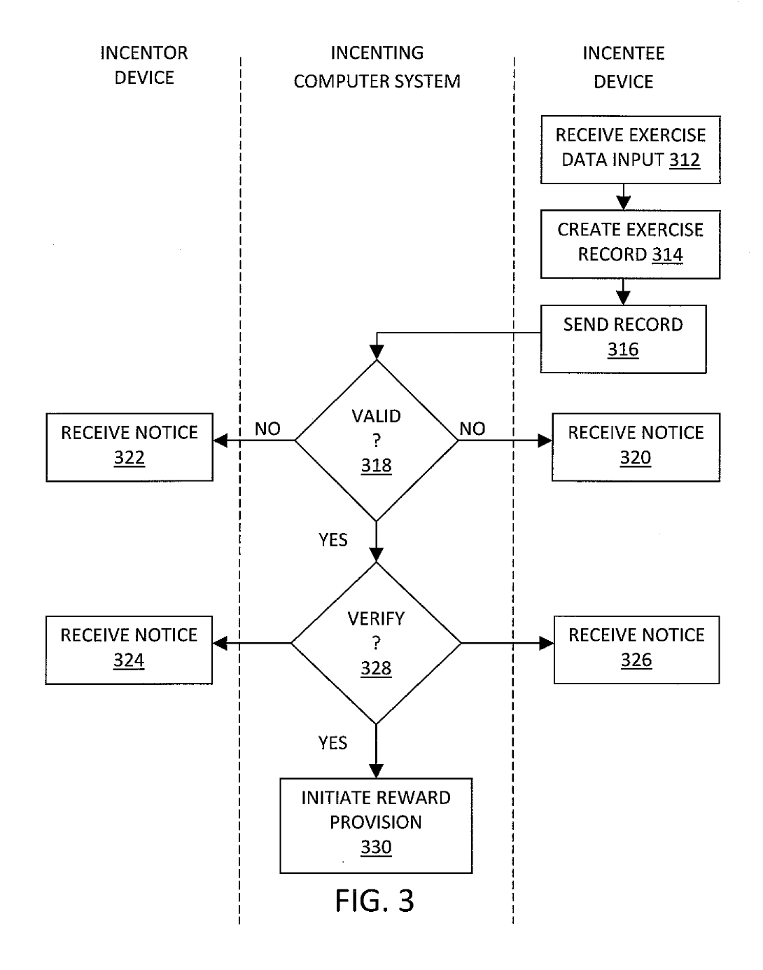

FIG. 3 depicts exercise record verification in accordance with various embodiments. The incentee device may receive exercise data input at 312. In embodiments, this exercise data may be input by an incentee user as self-reported data. In embodiments, the incentee user may exercise while wearing a monitoring device to record exercise data, such as physiological data, and manually input the recorded data into the incentee device. In alternative embodiments, the monitoring device may automatically upload the recorded data either wirelessly or via wired connection to the incentee device. In embodiments, the monitoring device and incentee device may be the same.

The incentee device may create an exercise record using the input data at 314. In embodiments, a monitoring device may create the exercise record. In such embodiments, the monitoring device may transmit the exercise record directly to the incenting computer system. In other embodiments, the monitoring device may transmit the exercise record to an incentee device which may then transmit to the incenting computer system. In embodiments, the exercise record may be in a tamper-resistant form such as an encrypted form. In embodiments where a monitoring device is used, the monitoring device may also transmit the recorded data in a tamper-resistant form. The incentee device may send the exercise record to the incenting computer system at 316. In embodiments, the sending may be automatic; in alternative embodiments, the incentee user or other person, including for example an incentor user, may manually transmit the exercise record. In embodiments where the monitoring device creates the exercise record, the monitoring device may transmit the exercise record directly to the incenting computer system.

The incenting computer system may validate the received exercise record at 318. In embodiments, such validation may include decrypting the data, validating a session key, a digital signature, or other validation. If the exercise record is invalid, the incentee device may receive a notice of invalidity at 320 and the incentor device may receive a notice of invalidity at 322. In embodiments, the incentor user may pre-determine the level of record validation required when initially proposing the arrangement and may change the level of validation required as the arrangement progresses such as, for example, if the incentor user discovers the incentee user has modified the exercise record. In embodiments, an incentee user may only be required to input the amount of exercise performed and little or no validation may be performed. Alternatively, the incentee user may be required to supply a detailed exercise record including a time and date.

The arrangement may require an encrypted exercise record or an exercise record with a security field. The monitoring device or incentee device may embed the security field in the exercise record before the exercise record is available to the incentee user to edit or manually upload. In embodiments, the entire exercise record, including the security field, may be electronic data readable as text by anyone or by exercise training diary software. In embodiments, the exercise record may include two parts, a plain text part and an encrypted part for decryption and verification by the incenting computer system. The encrypted exercise record may provide security against attempted fraud or record forgery by the incentee user or by another party and may protect against undetected communication errors.

In embodiments, the encrypted exercise record may protect the identity of the incentee user and/or private information of the incentee user before, during, and after transmission of the exercise record. The exercise record may be encrypted before transmission. In embodiments, a device—for example a monitoring device, the incentee device, or other device such as a cell phone—may encrypt the exercise record using public key or private key encryption. A hash code may be generated by a circuit or an algorithm using other data in the exercise record such as date, time, exercise intensity, and duration. The hash code or encryption may use a random number generator. The exercise record may contain a security field such as a checksum or a cyclic redundancy check or a cryptographic hash function such as SHA-256. The incenting computer system may decrypt before verifying the validity of the exercise record.

As an example only, an incentee user may use a monitoring device such as, for example, a heart rate monitor or ergometer, to record an exercise session and generate exercise data. The incentee device may use the exercise data to create an exercise record and transmit the exercise record to the incenting computer system; the incenting computer system may check that the exercise record is valid. If, however, the incentee user later copies the old exercise record, forges the date to appear as a second exercise record, and submits the altered record, the incenting computer system may use a security field or other field or validation technique to determine that the exercise record is invalid. In such a case, the incenting computer system may send invalidity notices to both the incentor device and the incentee device and the incentee user may not get credit for performing exercise and may not receive a reward.

In embodiments, the exercise record may be verification that the incentee user has performed the prescribed exercises expressed in the arrangement. The incenting computer system may, upon validation of the exercise record, verify whether the exercise record indicates that the incentee user has performed the prescribed exercise record at 328. In embodiments, the validated exercise record may be cumulative such as, for example, when the incentee user is working towards a long-term goal. In other embodiments, the validated exercise record alone may be sufficient to verify that the incentee user has performed the prescribed exercise or exercise level. If the exercise record verifies that the prescribed physical exercise or exercise level has been performed by the incentee user, the incentee device may receive notice of exercise verification at 326 and the incentor device may receive notice of exercise verification at 328. Then, the incenting computer device may provide the reward according to the arrangement at 330. In embodiments, the incenting computer system may determine the reward based upon the arrangement using information from the validated and verified exercise record. In embodiments, the reward may be provided to a reward recipient, such as for example a third party. In embodiments, the reward recipient may be the incentee user or the incentor user. In embodiments, all or some of the reward may be provided to a charitable organization or other entity or person.

In embodiments, the arrangement may provide that multiple iterations of the validation, verification, and rewarding procedure may occur before expiration of the arrangement. In embodiments, the arrangement may provide that an incentee user receive a reward for each hour of exercise at a prescribed exercise level. Such an arrangement may specify that the arrangement may last for a specific period of time and that the incentee user may receive an unlimited number of rewards, a limited number of rewards, or only one reward. As stated above, in embodiments, multiple exercise records may be required to verify that the incentee user has performed the prescribed physical exercise or exercise level.

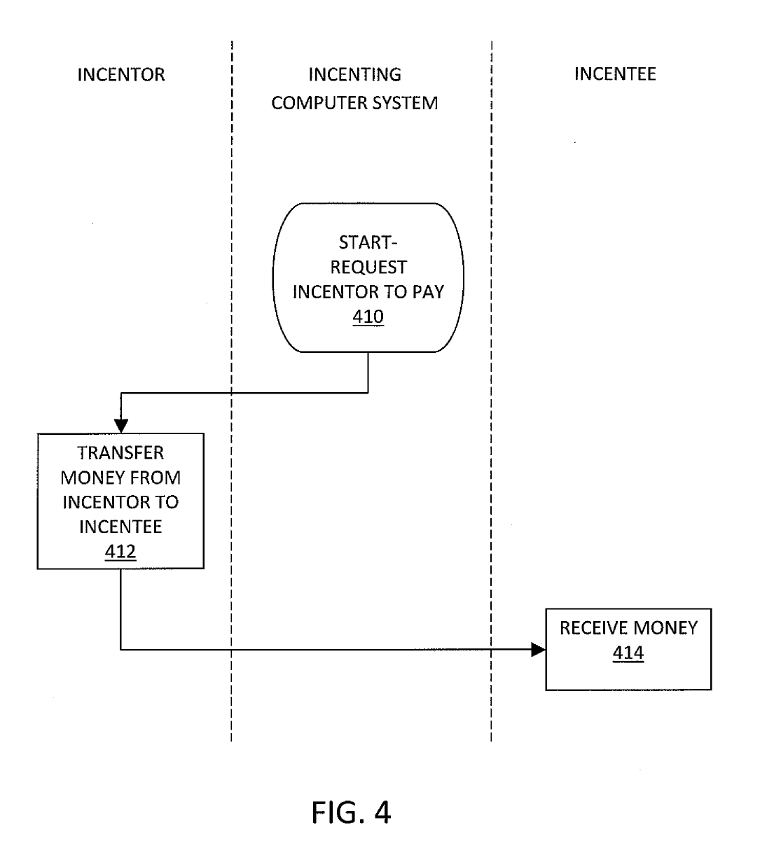

FIGS. 4-7 show various ways that the incenting computer system may initiate the provision or the providing of the prescribed reward. In embodiments, it will be understood that the reward may be provided by the incenting computer system.

FIG. 4 shows a reward provision initiating procedure wherein the incenting computer system initiates the provision of the reward by sending a notice to the incentee device requesting the incentee user to pay the incentor user directly. The incenting computer system sends the notice at 410. The incentor user may then transfer money to the incentee at 412. The incentee user may receive the money at 414. In embodiments, the transfer of money may be an electronic transfer of funds initiated either manually by the incentor user or automatically by the incentor device.

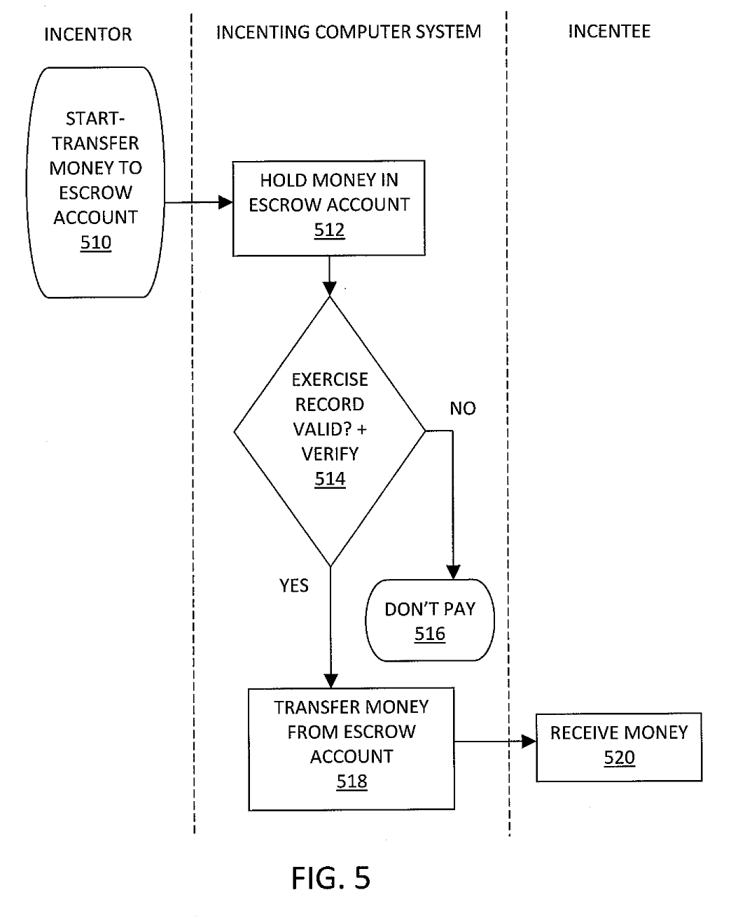

FIG. 5 shows the incenting computer system initiating the provision of the reward using a managed escrow account. The incentor device may send notice to the incenting computer system to deposit money into an escrow account at 510. The incenting computer system may then hold the money in the established escrow account at 512. Upon validation and/or verification of an exercise record at 514, the incenting computer system may transfer money from the escrow account 518 according to the arrangement and/or the information in the exercise record including, in embodiments, information provided in cumulative exercise records. The incentee device may receive notice that the money has been transferred from the escrow account at 520. If the exercise record is either invalid or unverified, no money may be transferred at 516. It will be understood that a valid but unverified exercise record may be saved and later considered along with a future exercise record to verify the future exercise record such as, for example, when the incentee user is working towards a long-term goal.

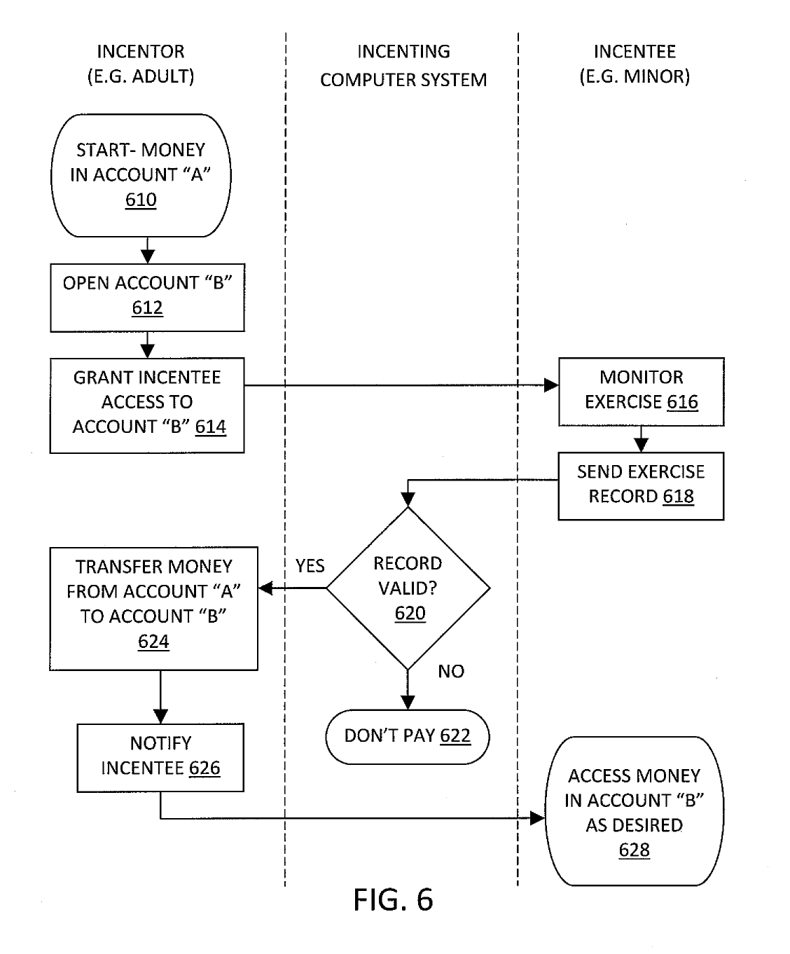

FIG. 6 shows the initiating of the provision of a reward wherein the incentor user (e.g. an adult) may have a master account and a payment account. In embodiments, the incentee user (e.g. a minor) may have access to the payment account. The incentor user may initially place money into account “A”—the master account—at 610. Then the incentor user may open account “B”—the payment account—at 612. The incentor user may grant, as part of the arrangement or otherwise, the incentee user access to account “B” at 614. For example an incentor device may transmit an account number and personal identification number (i.e. PIN) corresponding to the account to an incentee device. In embodiments both account “A” and account “B” may be in the incentor user's name. In embodiments, one or both accounts maybe in the incentee user's name. In embodiments one or both accounts may be in both the incentee and the incentor user's name (i.e. a joint account). In embodiments where the incentee user is a minor and the incentor user is an adult, both accounts may be in the incentor user's name. In embodiments where the incentor user is a minor and the incentee user is an adult, both accounts may be in the incentee user's name. In embodiments where both the incentee user and the incentor user are minors, the account may be held by a third party such as, for example, a parent or guardian of one or both of the incentee user and the incentor user. The incentee user may perform and record physical exercise at 616. The incentee user may send an exercise record to the incenting computer system at 618. The incenting computer system may validate and verify the record at 620. As described elsewhere, such validation and verification may be according to the incentor's criteria and/or an incenting arrangement. If the record is invalid, the incentee user may not receive a reward at 622. If the record is valid, the incenting computer system may notify the incentor user and the incentor user may manually transfer money from account “A” to account “B” at 624. The incentor user may notify the incentee user at 626 that the money has been transferred. The incentee user may then access the money in account “B” as desired at 628.

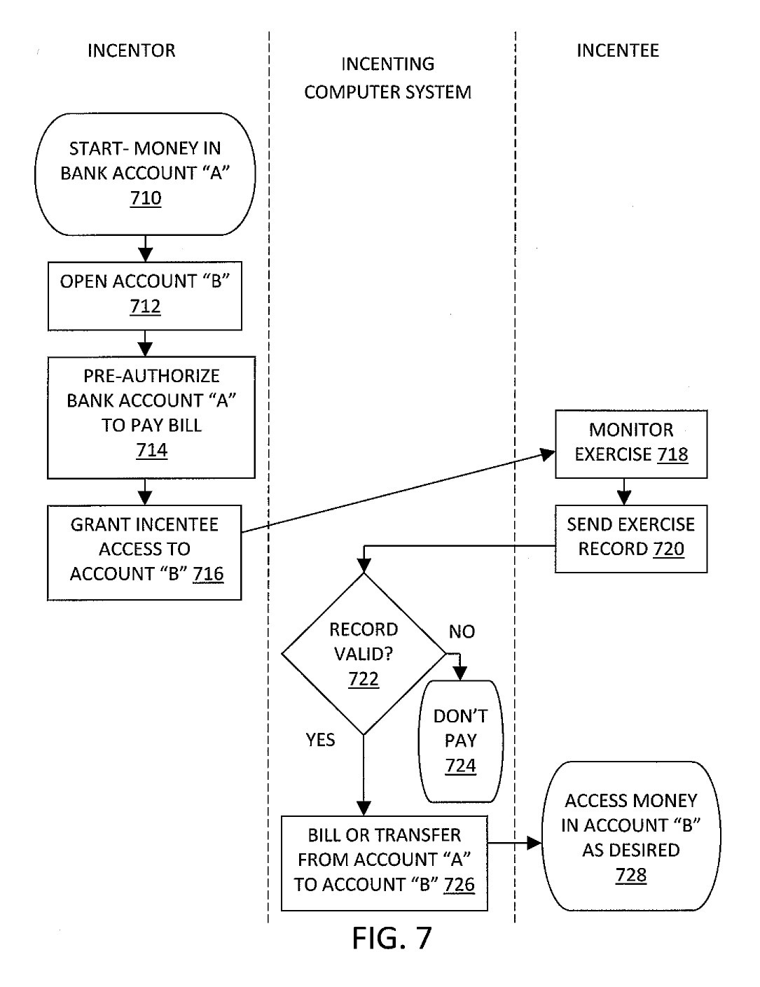

FIG. 7 shows another way the incenting computer system initiates providing of a reward wherein the incentor user preauthorizes payments from one account to another in accordance with various embodiments. The incentor user may have two accounts—a master account “A” and a payment account “B”; the incentee user may be granted access to account “B”. The incentor user may begin by transferring money into bank account “A” at 710. The incentor user may then open account “B” at 712. In embodiments, account “B” may be held at a bank; in embodiments, account “B” may be held or controlled by the incenting computer system. The incentor user may pre-authorize the financial institution holding account “A” to pay bills from a party or organization associated with the incenting computer system or other party or organization. The incentor user may grant the incentee user access to account “B” at 716. The incentee may perform and monitor exercise at 718. The incentee user may send an exercise record to the incenting computer system at 720. The incenting computer system may verify and/or validate the exercise record at 722. If the record is invalid or unverified, the incentee user may not receive a reward at 724. If the record is valid and verified, the incenting computer system may bill account “A” and/or transfer money from account “A” to account “B” at 726. The incentee user may access the money in account “B” as desired at 728.

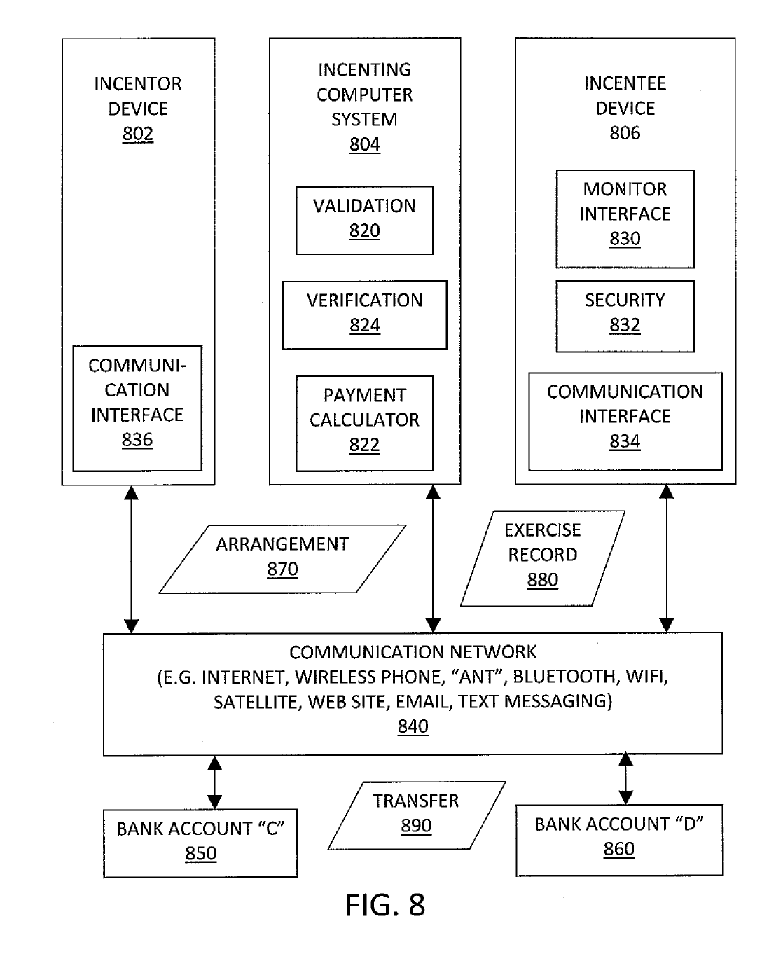

FIG. 8 shows a block diagram of a physical exercise incenting facilitation system in accordance with various embodiments. The various devices may communicate through communication network 840. In embodiments, communication network 840 may be a public network such as, for example, the internet. In embodiments, communication network 840 may be a wireless communications network. In embodiments, communication network 840 may be a personal area network (PAN) such as, for example ANT™, Bluetooth™, networks compatible with IEEE 802.15 and related specifications, ZigBee, and others. In embodiments, communications network may include other wireless connections such as, for example, those based on or compatible with the IEEE 802.11 specifications. In embodiments, communications network 840 may be satellite. In embodiments, higher layer protocols such as, for example, FTP, HTTP, SMTP, POP3, SMS and others may be used to carry data over communication network 840. Embodiments are not meant to be limited by any particular communications networks or protocols. In embodiments, incentor device 802 may use communication network 840 to send a request to establish arrangement 870 to incenting computer system 804. Incentee device 806 may use communication network 840 to send exercise record 880 to incenting computer system 804. In embodiments, communication network 840 may be used to electronically transfer digital money 890 from and to bank account “C” 850 and bank account “D” 860. Incentee device 806 may include monitoring device interface 830 for communicating exercise data and/or exercise records to and from a monitoring device (not shown) that may be, in embodiments, worn by an incentee user when performing physical exercise. In embodiments, incentee device 806 may include security module 832 to secure exercise record 880. Incentee device 806 may use communication interface 834 to connect to communication network 840. Similarly, incentor device 802 may include communication interface 836.

Incenting computer system 804 may include a validation module 820 to validate exercise record 880, a verification module 824 to verify exercise record 880, and a payment calculator module 822 to provide or initiate providing or provisioning of a reward, such as digital money 890. In embodiments, incenting computer system may include payment servers/modules (not shown), network components (not shown), and other devices.

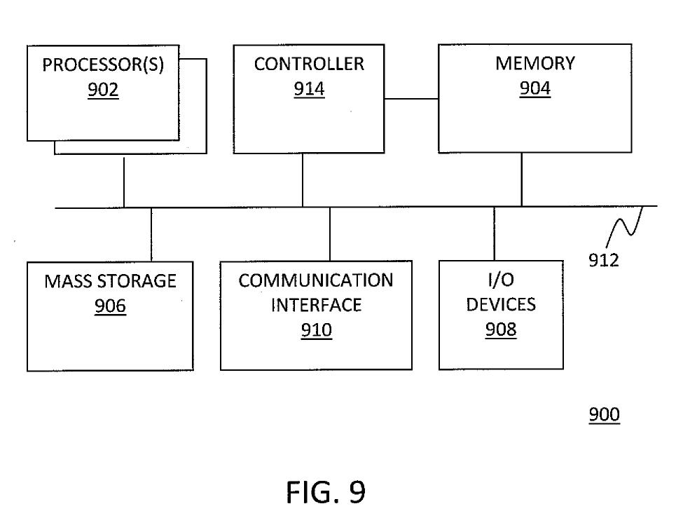

FIG. 9 illustrates an example computing system/device suitable for use to practice various embodiments of the present invention. Such a computing system/device may be used as an incentor device, incentee device, or as one or more components of incenting computer system such as those described elsewhere within this application. As shown, computing system/device 900 may include one or more processors 902, and system memory 904. Additionally, computing system/device 900 may include mass storage devices 906 (such as diskette, hard drive, CDROM and so forth), input/output devices 908 (such as keyboard, cursor control and so forth) and communication interfaces 910 (such as network interface cards, modems and so forth). The elements may be coupled to each other via system bus 912, which represents one or more buses. In the case of multiple buses, they may be bridged by one or more bus bridges (not shown). All or portion of system memory 904 may be endowed with all or portions of the teachings of the present invention, earlier described.

Other than the teachings of the various embodiments of the present invention, each of the elements of computer system/device 900 may perform its conventional functions known in the art. In particular, system memory 904 and mass storage 906 may be employed to store a working copy and a permanent copy of programming instructions implementing one or more software applications such as various software applications described elsewhere in this application.

Although FIG. 9 depicts a computer system, one of ordinary skill in the art will recognize that embodiments of the present invention may be practiced using other devices including, but not limited to, mobile telephones, Personal Data Assistants (PDAs), gaming devices, gaming consoles, monitoring devices such as heart rate monitors or others, high-definition television (HDTV) devices, appliances, networking devices, digital music players, laptop computers, portable electronic devices, telephones, as well as other devices known in the art.

Although specific embodiments have been illustrated and described herein for purposes of description of the preferred embodiment, it will be appreciated by those of ordinary skill in the art that a wide variety of alternate and/or equivalent implementations may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein.

What is claimed is:

1. A method comprising:
receiving, by one or more computer systems, verification that an incentee user has performed a physical exercise, the physical exercise being prescribed by an incenting arrangement wherein the incentee user agrees to perform the physical exercise in order to obtain a reward for a reward recipient; and
initiating, by the one or more computer systems upon receipt of said verification, a provision of the reward to the reward recipient.

2. The method of claim 1, further comprising facilitating by the one or more computer systems, a setup of the incenting arrangement.

3. The method of claim 2, wherein the facilitating includes receiving by the one or more computer systems from a device of an incentor user a request to establish the incenting arrangement including arrangement details, forwarding by the one or more computer systems, the request and the arrangement details to a device of the incentee user, and receiving by the one or more computer systems, from the device of the incentee user, an agreement to establish the arrangement.

4. The method of claim 2 wherein the facilitating by the one or more computer systems of the setup of the incenting arrangement is initiated by the incentee user.

5. The method of claim 1, wherein the incentee user and the reward recipient are the same user.

6. The method of claim 1, wherein the verification includes a level of physical exercise.

7. The method of claim 6, wherein the level of physical exercise includes physiological data of the incentee.

8. The method of claim 7, wherein the physiological data includes at least one of heart rate information, energy information, body mass index information, respiration rate or body weight information.

9. The method of claim 8, wherein the heart rate information includes an amount of time the incentee user has spent with a heart rate above a predetermined level and the energy information includes either a total number of Calories burned, or an amount of time the incentee user has spent with a metabolic rate above a predetermined level.

10. The method of claim 6, wherein the level of physical exercise includes at least one of an amount time spent performing the physical exercise, a number of occurrences of the incentee user performing the physical exercise over a period of time, a number of footsteps, a total distance traveled, a level of force executed by the incentee user, and a speed achieved by the incentee user.

11. The method of claim 1, wherein the reward comprises monetary credit, the reward recipient is the incentee user, and said provision includes transferring the monetary credit from an account of an incentor user to an account of the incentee user.

12. The method of claim 1, wherein the verification includes data collected by a monitoring device worn by the incentee user while performing the physical exercise.

13. The method of claim 1, wherein the receiving comprises receiving by the one or more computer system an automatic upload of the data from the monitoring device.

14. The method of claim 1, wherein the verification is received in a tamper-resistant data form.

15. An apparatus comprising:
one or more processors;
one or more mass storage devices coupled to the one or more processors; and
a plurality of programming instructions stored in the one or more mass storage devices and configured to program the one or more processors to:
receive verification that an incentee user has performed a physical exercise, the physical exercise prescribed by an incenting arrangement wherein an incentee user agrees to perform the physical exercise in order to obtain a reward for a reward recipient; and
initiate, upon receipt of said verification, a provision of the reward to the reward recipient.

16. The apparatus of claim 15, wherein the plurality of programming instructions are further configured to program the one or more processors to:
receive, from a device of an incentor user, a request to establish the incenting arrangement including arrangement details;
forward the request and the arrangement details to a device of the incentee user; and
receive, from the device of the incentee user, an agreement to establish the arrangement.

17. The apparatus of claim 15, wherein the plurality of programming instructions are further configured to program the one or more processors to receive an automatic upload of the data from a monitoring device worn by the incentee user while performing the physical exercise.

18. A method comprising:
receiving, by a client device, exercise data from a monitoring device worn by an incentee user while the user performs physical exercise;
encoding, by the client device, the received exercise data in a tamper-resistant format; and
sending, by the client device to a server, the encoded exercise data.

19. The method of claim 18, wherein the wherein the exercise data includes a level of physical exercise.

20. The method of claim 19, wherein the level of physical exercise includes physiological data of the incentee including at least one of heart rate information, energy information, body mass index information, respiration rate, or body weight information.

21. The method of claim 19, wherein the level of physical exercise includes at least one of an amount time spent performing the physical exercise, a number of occurrences of the incentee user performing the physical exercise over a period of time, a number of footsteps, a total distance traveled, and an average speed.
